(19) United States
(12) Patent Application Publication
(10) Pub. No.: US 2015/0267657 A1
(43) Pub. Date: Sep. 24, 2015

(54) Quick Twist Disconnect Device and System

(71) Applicant: CATERPILLAR INC., Peoria, IL (US)

(72) Inventor: Bryant Morris, Peoria, IL (US)

(73) Assignee: CATERPILLAR INC., Peoria, IL (US)

(21) Appl. No.: 14/223,027

(22) Filed: Mar. 24, 2014

(51) Int. Cl. F02M 37/22; B65D 53/02; B01D 29/07; B01D 35/30; B01D 35/00; B65D 25/28; B65D 43/26

(52) U.S. Cl. CPC F02M 37/22; B65D 25/28; B65D 53/02; B65D 43/26; B01D 35/306; B01D 35/005; B01D 29/07; B65D 2525/284

(57) ABSTRACT

A filter cartridge assembly includes a fitting with a lid and a throat. The lid includes a handle and spring. The handle is configured to receive torque and linear force and translate these forces to the lid. The spring has a first and second catch disposed opposite ends. The spring is configured to mate with and fully reside within a lid groove in response to the first catch being drawn towards the second catch. The spring is configured to partially extend annularly outwardly from the lid groove in response to the first catch and the second catch being allowed to return to a biased position. The throat receives the lid and a throat groove disposed about the throat is configured to receive the extended portion of the spring partially extending from the lid groove. The lid is captured in response to the spring mating with the throat groove.

### TECHNICAL FIELD

This patent disclosure relates generally to a closure system and, more particularly, to a quick twist disconnect closure for a filter housing.

### BACKGROUND

Liquid filter drains are known for draining filter housings of accumulated contaminants. In internal combustion engines, for example, filters are used to remove contaminants from oil, fuel, hydraulic fluids and other such fluids. In a particular example, a fuel line filter is used to separate out water and debris.

In order to properly maintain the engine or power source, the various filters are periodically checked and replaced as the filter medium becomes saturated with debris. Conventional filters require tools such as one or a pair of wrenches to disassemble the filter housing from the fluid line or mounting. Such tools may be easily lost or stolen from job sites and must also be maintained.

US Publication No. 2007/0221561A1 (hereinafter “the '561 publication”), entitled “Liquid Filtration System,” purports to describe a tool-less system for checking and replacing a filter. However, the end cap of the pressure vessel that houses the filter of the '561 publication does not provide even support about the perimeter of the end cap. In addition, the end cap must be turned about 90° in order to assemble or disassemble the pressure vessel. While this may be acceptable in the open pitcher envisioned by the authors of the '561 publication, it may be less desirous in the power source compartment of a large earthmoving machine or other such vehicle or device.

Accordingly, there is a need for an improved closure system to address the problems described above and/or problems posed by other conventional approaches.

### SUMMARY

The foregoing needs are met, to a great extent, by the present disclosure, wherein aspects of an improved liquid filter drain are provided.

In one aspect, the disclosure describes a fitting includes a lid and a receiver. The lid includes a circular body, a handle, an annular lid groove, and an annular spring. The circular body is defined by a first surface, a second surface, and a perimeter. The handle is disposed upon the first surface and is configured to receive torque and linear force and translate the torque and linear force to the circular body. The annular lid groove is disposed about the perimeter. The annular spring has a spring body, a first catch disposed at a first end of the spring body, and a second catch disposed at a second end of the spring body. The spring body is configured to mate with the annular lid groove. The spring body is configured to fully reside within the annular lid groove in response to the first catch being drawn towards the second catch. The spring body is configured to partially extend annularly outwardly from the annular lid groove in response to the first catch and the second catch being allowed to return to a biased position. The receiver includes a throat and a throat groove. The throat is defined by a cylindrical surface configured to mate with the perimeter of the circular body. The throat groove is disposed about the throat. The throat groove is configured to receive the extended portion of the spring body partially extending from the annular lid groove. The lid is captured in the receiver in response to the spring body mating with the throat groove.

In another aspect, the disclosure describes a filter cartridge assembly to filter a fluid. The filter cartridge assembly includes a housing having an inlet and an outlet, a filter medium disposed in the housing between the inlet and the outlet and a fitting. The fitting includes a lid and a receiver. The lid includes a circular body, a handle, an annular lid groove, and an annular spring. The circular body is defined by a first surface, a second surface, and a perimeter. The handle is disposed upon the first surface and is configured to receive torque and linear force and translate the torque and linear force to the circular body. The annular lid groove is disposed about the perimeter. The annular spring has a spring body, a first catch disposed at a first end of the spring body, and a second catch disposed at a second end of the spring body. The spring body is configured to mate with the annular lid groove. The spring body is configured to fully reside within the annular lid groove in response to the first catch being drawn towards the second catch. The spring body is configured to partially extend annularly outwardly from the annular lid groove in response to the first catch and the second catch being allowed to return to a biased position. The receiver includes a throat and a throat groove. The throat is defined by a cylindrical surface configured to mate with the perimeter of the circular body. The throat groove is disposed about the throat. The throat groove is configured to receive the extended portion of the spring body partially extending from the annular lid groove. The lid is captured in the receiver in response to the spring body mating with the throat groove.

In yet another aspect, the disclosure describes a machine having a filter cartridge assembly to filter a fluid. The filter cartridge assembly includes a housing having an inlet and an outlet, a filter medium disposed in the housing between the inlet and the outlet and a fitting. The fitting includes a lid and a receiver. The lid includes a circular body, a handle, an annular lid groove, and an annular spring. The circular body is defined by a first surface, a second surface, and a perimeter. The handle is disposed upon the first surface and is configured to receive torque and linear force and translate the torque and linear force to the circular body. The annular lid groove is disposed about the perimeter. The annular spring has a spring body, a first catch disposed at a first end of the spring body, and a second catch disposed at a second end of the spring body. The spring body is configured to mate with the annular lid groove. The spring body is configured to fully reside within the annular lid groove in response to the first catch being drawn towards the second catch. The spring body is configured to partially extend annularly outwardly from the annular lid groove in response to the first catch and the second catch being allowed to return to a biased position. The receiver includes a throat and a throat groove. The throat is defined by a cylindrical surface configured to mate with the perimeter of the circular body. The throat groove is disposed about the throat. The throat groove is configured to receive the extended portion of the spring body partially extending from the annular lid groove. The lid is captured in the receiver in response to the spring body mating with the throat groove.

There has thus been outlined, rather broadly, certain aspects of the disclosure in order that the detailed description thereof herein may be better understood, and in order that the present contribution to the art may be better appreciated. There are, of course, additional aspects that will be described below and which will form the subject matter of the claims appended hereto.

In this respect, before explaining at least one example in detail, it is to be understood that the disclosure is not limited in its application to the details of construction and to the arrangements of the components set forth in the following description or illustrated in the drawings. The disclosed device and method is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the various aspects. It is important, therefore, that the claims be regarded as including such equivalent constructions insofar as they do not depart from the spirit and scope of the various aspects.

### BRIEF DESCRIPTION OF THE DRAWINGS

FIG. 1 is a side view of an exemplary machine, according to an aspect of the disclosure.

FIG. 2 is a perspective view of a filter cartridge assembly, according to an aspect of the disclosure.

FIG. 3 is an exploded view of the filter cartridge assembly, according to an aspect of the disclosure.

FIG. 4 is a cross sectional view of the filter cartridge assembly showing the flow of fluid therethrough, according to an aspect of the disclosure.

FIG. 5 is a cross sectional perspective view of the filter cartridge assembly, according to an aspect of the disclosure.

FIG. 6 is a perspective view of a lid, according to an aspect of the disclosure.

FIG. 7 is a perspective view of a lip, according to an aspect of the disclosure.

FIG. 8 is a perspective view of the filter cassette secured to a lid, according to an aspect of the disclosure.

FIG. 9 is a detailed cross sectional view of a portion of the filter cartridge assembly, according to an aspect of the disclosure.

FIG. 10 is a cross sectional view of the filter cartridge assembly, according to another aspect of the disclosure.

FIG. 11 is a perspective view of the lip, according to another aspect of the disclosure.

FIG. 12 is a perspective view of the lid, according to another aspect of the disclosure.

FIG. 13 is a partial exploded view of the filter cartridge assembly, according to yet another aspect of the disclosure.

FIG. 14 is a cross sectional view of the filter cartridge assembly, according to yet another aspect of the disclosure.

### DETAILED DESCRIPTION

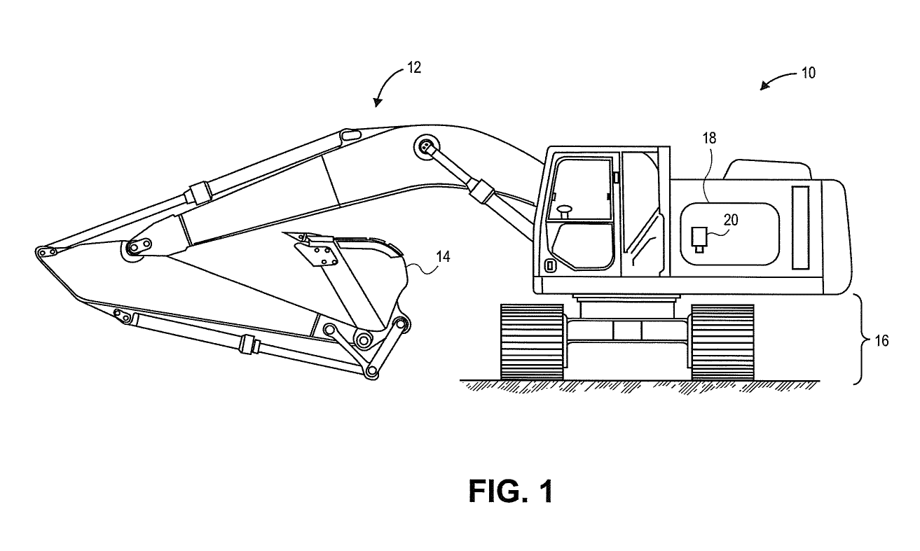

FIG. 1 illustrates an exemplary machine 10 having various systems and components that cooperate to accomplish a task. The machine 10 may embody a fixed or mobile machine that performs some type of operation associated with an industry such as mining, construction, farming, transportation, power generation, or another industry known in the art. For example, the machine 10 may be an earth moving machine such as an excavator (shown in FIG. 1), a dozer, a loader, a backhoe, a motor grader, a dump truck, or another earth moving machine. The machine 10 may include an implement system 12 configured to move a work tool 14, a drive system 16 for propelling the machine 10, a power source 18.

In a particular example, the power source 18 includes an engine configured to combust a fuel such as diesel and this fuel is filtered at a filter cartridge assembly 20. As fuel passes through the filter cartridge assembly 20, contaminants such as water, debris, and the like are filtered out and collect in the filter cartridge assembly 20. Periodically, the filter cartridge assembly 20 is inspected to determine if a filter medium (described further herein) disposed within the filter cartridge assembly 20 should be replaced. For example, if sufficient debris has collected on the filter medium, the filter medium may be replaced. As described herein, it is an advantage of embodiments of the filter cartridge assembly 20 that the filter cartridge assembly 20 is easier and less time consuming to inspect and replace the filter medium than conventional filter cartridges. It is another advantage of embodiments of the filter cartridge assembly 20 that the filter medium may be inspected and replace without directly contacting the filter medium. These and other advantages are described herein. Of note, while particular example is made throughout of filtering fuel, the various embodiments are not limited to filtering fuel, but rather, include any suitable filtering application. Examples of suitable filtering applications include hydraulic, lubricant, air, or other such filtration systems.

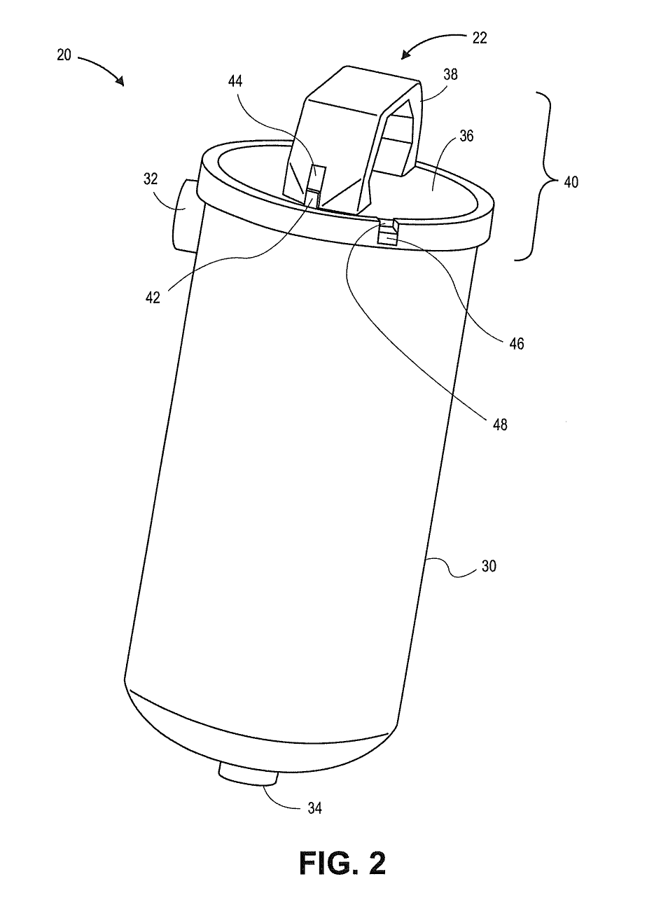

FIG. 2 is a perspective view of the filter cartridge assembly with a lid 22 in a closed conformation, according to an aspect of the disclosure. As shown in FIG. 2, the filter cartridge assembly 20 includes a housing 30, fuel inlet 32, fuel outlet 34, and the lid 22. In general, the housing 30 and/or lid 22 may include any suitable material such as, for example, metals, plastics, elastomers, and the like. In a particular example, the housing 30 and/or lid 22 is primarily a resin or polymer formed into a cylindrical shell and incorporating elastomeric seals. In another particular example, the housing 30 is primarily sheet metal formed into a cylindrical shell and incorporating elastomeric seals. In yet another particular example, the housing 30 is a cast metal shell to which machined surfaces are subsequently milled and/or elastomeric seals are later added.

The lid 22 includes a circular body 36 and a handle 38 disposed on the circular body 36. The handle 38 is configured to receive torque and linear force and translate the torque and linear force to the circular body 36. For example, a user or technician may grasp the handle 38, turn the handle 38 relative to the housing 30, and draw the lid 22 from the housing 30 in response to a fitting 40 being released. While the various elements of the fitting 40 are further described herein, a few elements that are visible in FIG. 2 include a first catch 42 disposed or captured in a lid notch 44 and a second catch 46 disposed or captured in a lip notch 48. The lip notch 48 is disposed on a lip 50 of the housing 30. In order to release the fitting 40, the handle 38 is rotated relative to the housing 30 so that the first catch 42 is drawn towards the second catch 46. In the particular example shown, the handle 38 is rotated counterclockwise. Of note, the first catch 42 and the second catch 46 are initially separated by less than 15° of rotation and the fitting 40 is configured to release prior to the first catch 42 and the second catch 46 being in alignment. As such, the lid 22 may be released from the housing 30 with less than 15° of rotation. In some particular examples, the lid 22 may be released from the housing 30 with about 5°, 7°, 10°, 12° of rotation or the like. Again, the workings of the fitting 40 are further described herein.

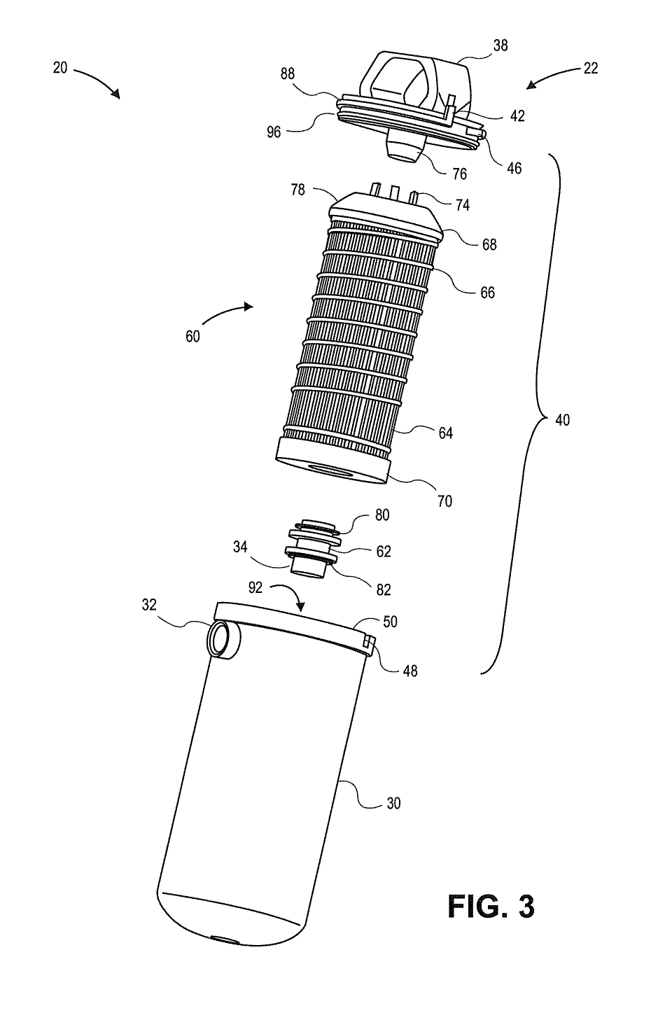

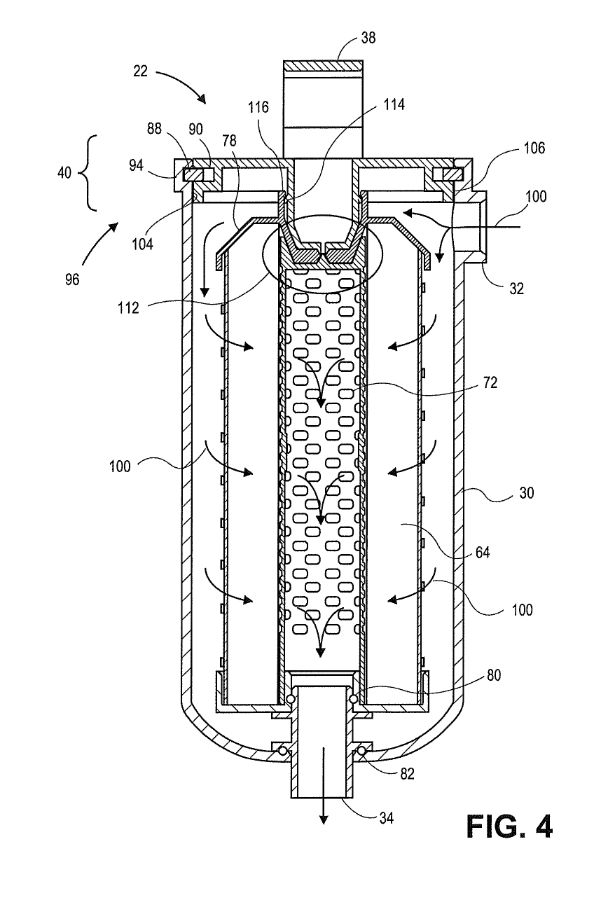

FIG. 3 is an exploded view of the filter cartridge assembly 20, according to an aspect of the disclosure. As shown in FIG. 3, the filter cartridge assembly 20 includes a filter cassette 60 and adapter 62. The filter cassette 60 includes a filter media 64, spiral roving 66, top cap 68, and bottom cap 70. The filter media 64 includes any suitable medium for filtering particulate or other contaminants from a fluid such as air, water, coolant, oil, fuel, and the like. Examples of suitable filtering medium include pleated cellulose stock, felted polymers, open cell foamed polymers, spun fibers, and the like. In a particular example, the filter media 64 is a matted cellulose fiber stock that is pleated and disposed about a center tube 72 (shown in FIG. 4). The spiral roving 66 is configured to retain separation between adjacent ones of the pleats. The spiral roving 66 may be affixed to the filter media 64 via an adhesive.

The top cap 68 covers the top end of the filter media 64 to reduce or prevent a flow of fluid from bypassing the filter media 64. The top cap 68 includes a retention clip 74 that is configured to engage a filter mounting post 76. The filter mounting post 76 extends down from the lid 22. In a particular example, the filter mounting post 76 extends axially from the center of the lid 22. As described herein, the retention clip 74 and filter mounting post 76 may be permanently or releaseably affixed to one another and, in this manner, the handle 38 provides the user with the ability to remove the filter media 64 without directly coming into contact with the filter media 64. The top cap also includes a sloping face 78. This sloping face 78 increases the volume available for an incoming flow of fluid to disperse about the filter media 64. In this manner, flow velocity can be maintained about the filter media 64.

The bottom cap 70 covers the bottom end of the filter media 64 in a manner similar to the top cap 68. The adapter 62 is configured to provide a conduit to convey a flow of the filtered fluid from the filter media 64 to the fuel outlet 34. In a particular example, the adapter 62 includes a filter seal 80 configured to reduce or prevent intermixing of filtered fluid with unfiltered fluid. In a particular example, the filter seal 80 includes an O-ring to form a seal between the adapter 62 and the bottom cap 70. The adapter 62 may also include a housing seal 82 configured to reduce or prevent leakage from the housing 30. In a particular example, the housing seal 82 includes an O-ring to form a seal between the adapter 62 and the housing 30.

Also shown in FIG. 3, the lid 22 includes an annular spring 88 disposed in a lid groove 90 disposed about a perimeter of the lid 22. The first catch 42 and second catch 46 are disposed at opposite ends of the annular spring 88. In response to the first catch 42 being drawn towards the second catch 46, the diameter of the annular spring 88 is reduced and the annular spring 88 is drawn into the lid groove 90. The annular spring 88 is biased to a diameter in which at least a portion of the annular spring 88 extends out from the lid groove 90. When the lid 22 is placed in a throat 92 of the housing 30, a throat groove 94 (shown in FIG. 4) is configured to receive the portion of the annular spring 88 that extends out from the lid groove 90. As such, if the diameter of the annular spring 88 is reduced or compressed via the application of torque upon the annular spring 88 then, in response to reducing the torque to a level below that of a bias strength of the annular spring 88, the annular spring 88 is configured to return to a diameter in which at least a portion of the annular spring 88 extends out from the lid groove 90 and locks the lid 22 into the throat 92.

The lid 22 further includes a lid seal 96 disposed about the perimeter of the lid 22. As shown in FIG. 3, the lid seal 96 is disposed relatively below the annular spring 88. As shown in FIG. 4, the lid seal 96 is configured to form a seal between the perimeter of the lid 22 and an inside surface of the housing 30. Of note, while the lid 22 is shown relatively above the housing 30, other examples of the lid 22 and/or fitting 40 need not be disposed at a top portion of the filter cartridge assembly 20, but rather, may be disposed at a bottom, lower, middle, and/or upper portion of the filter cartridge assembly 20 or any other suitable container.

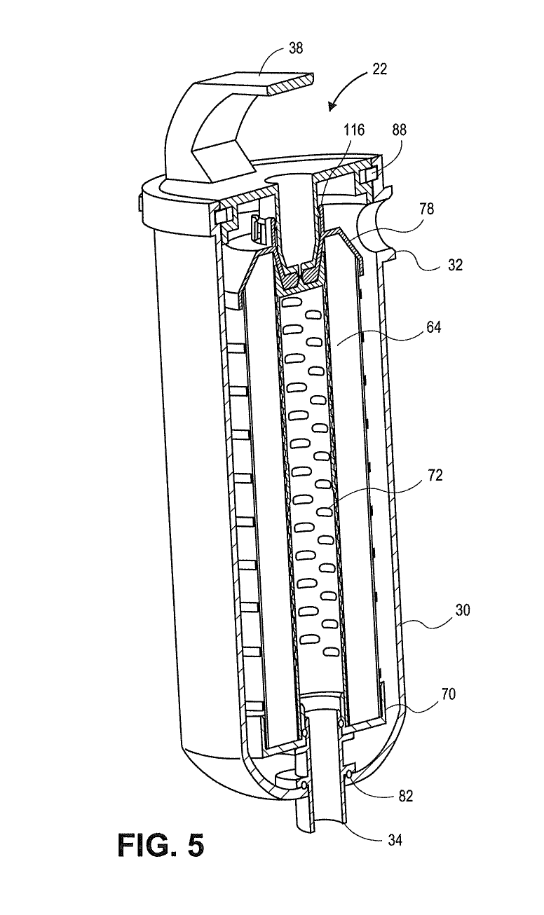

FIGS. 4 and 5 are cross sectional views of the filter cartridge assembly 20 showing the flow of fluid therethrough, according to an aspect of the disclosure. As shown in FIG. 4, a series of flow lines 100 illustrates the flow of the fuel. The fuel enters via the fuel inlet 32 and passes into a distribution zone 102 of the filter cartridge assembly 20. The distribution zone 102 includes a toroid or ‘donut’ shaped volume that may be better understood from the perspective cross sectional view in FIG. 5. The distribution zone 102 is generated by the sloping face 78 that covers the cut portion of the filter media 64 and facilitates an even and low-restriction flow of the fuel about an upper portion of the filter cassette 60. This distribution of the flow of fuel about the upper portion of the filter cassette 60 facilitates improved flow around and down the filter cassette 60 and reduces low-flow areas which improves the filter performance of the filter cartridge assembly 20.

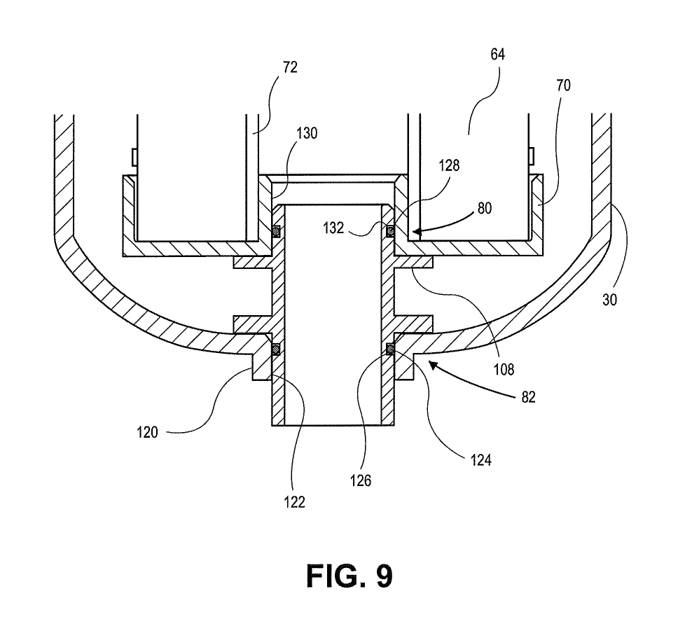

Also shown in FIG. 4 is that the lid seal 96 includes a lid groove 104 that provides a seat for an O-ring 106. The lid seal 96 is configured to form a seal between the perimeter of the lid 22 and the cylindrical inner surface of the throat 92. More particularly, the O-ring 106 forms a radial seal between the lid groove 104 and the throat 92. It is an advantage of this lid seal 96 that the radial sealing action does not rely upon a downward compressive force to maintain the seal. As such, no load is placed on the fitting to maintain the lid seal 96. In a similar manner, the filter seal 80 is depicted as a radial seal between the adapter 62 and the center tube 72. In contrast, the housing seal 82 is depicted as a surface mount seal. In order to translate compressive force down from the fitting 40 to the housing seal 82 and/or secure the filter cassette 60 within the housing 30, the adapter 62 includes a filter flange 108 and a housing flange 110. The relative position of the filter flange 108 and housing flange 110 on the adapter 62 determines the compressive force translated to the housing seal 82. However, due to the relatively small diameter of the housing seal 82 in comparison to the lid seal 96, relatively little pressure is sufficient to maintain the housing seal 82. An advantage of the housing seal 82 shown in FIG. 4 is that manufacturing of the housing 30 is simplified. In another example of filter cartridge assembly 20 shown in FIG. 9, the housing seal 82 is a radial-type seal.

Returning to FIG. 4, an interface seal 112 is shown that is formed between the top cap 68 and the filter mounting post 76. The interface seal 112 includes a plurality of angled mating surfaces that provides a secure and positive fit between the top cap 68 and the filter mounting post 76. To further secure the filter cassette 60 to the lid 22, the filter mounting post 76 includes an annular ridge 114 that is configured to engage a retention clip catch 116. In order to facilitate removal of the filter cassette 60 from the lid 22, the filter mounting post 76 may include a vent 118 to provide an inlet for air. In this manner, a partial vacuum locking the filter cassette 60 to the lid 22 may be avoided.

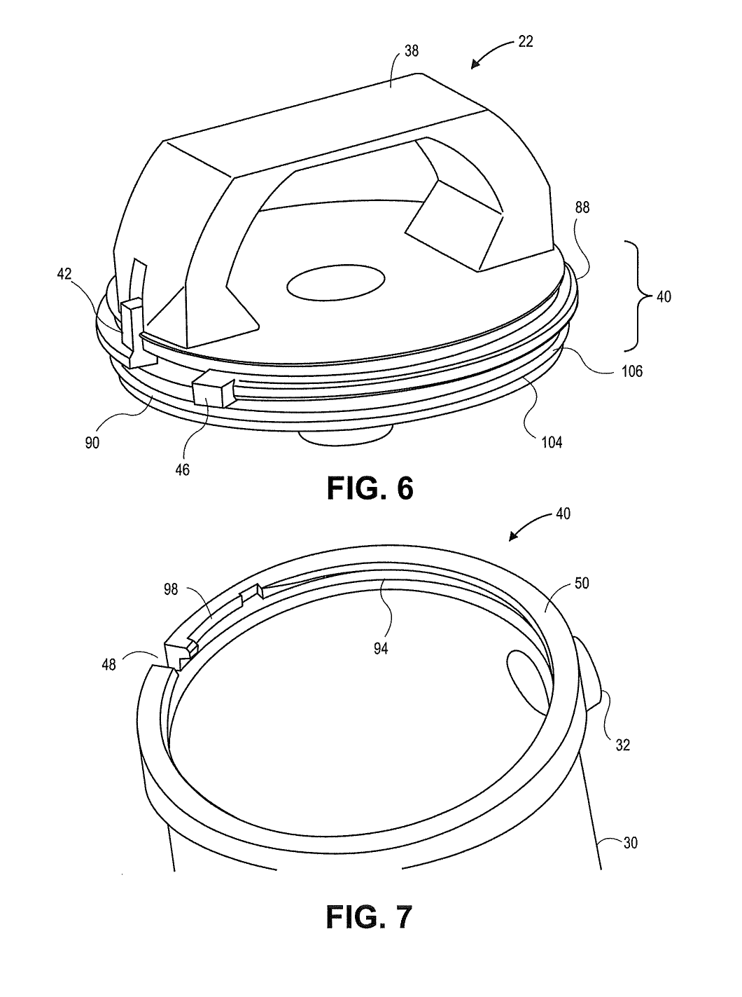

FIGS. 6 and 7 are perspective views of the lid 22 and lip 50, according to an aspect of the disclosure. As shown in FIG. 6, in the biased position, the annular spring 88 protrudes from the lid groove 90. In addition, the O-ring 106 is retained in the lid groove 104. As shown in FIG. 7, the lip 50 includes a recess 98 to facilitate rotation of the first catch 42 along the lip 50. That is, first catch 42 may protrude and the recess facilitates this. In other examples, the first catch 42 may fully seat within the lid notch 44 and lip 50 may not include the recess 98. Of note, because the annular spring 88 is retained within the throat groove 94 along substantially the entire circumference of the lid 22, the fitting 40 is relatively more secure and/or robust than fittings that are not fully supported.

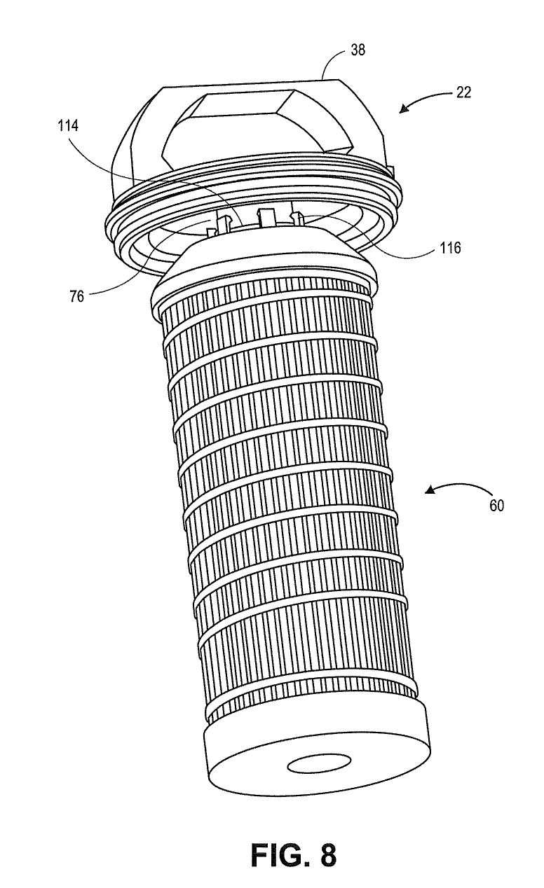

FIG. 8 is a perspective view of the filter cassette 60 secured to the lid 22, according to an aspect of the disclosure. As shown in FIG. 8, by securing the lid 22 to the filter cassette 60, filter media 64 is easily inspected or replaced without touching the filter media. Instead, the user may grasp the handle 38 to inspect or replace the filter cassette 60. Also shown in FIG. 8, the top cap 68 includes a plurality of the retention clip catches 116 that are arranged about the top cap 68 to engage the annular ridge 114 of the filter mounting post 76.

FIG. 9 is a detailed cross sectional view of a portion of the filter cartridge assembly 20, according to an aspect of the disclosure. As shown in FIG. 9, the housing 30 includes an outlet flange 120 to provide an elongated cylindrical housing sealing surface 122. The housing seal 82 is formed via the interaction of an O-ring 124 disposed between the housing sealing surface 122 and a housing seal groove 126 disposed about the adapter 62. Also shown in FIG. 9, the filter seal 80 is formed via the interaction between an O-ring 128 disposed between a filter sealing surface 130 and a filter sealing groove 132.

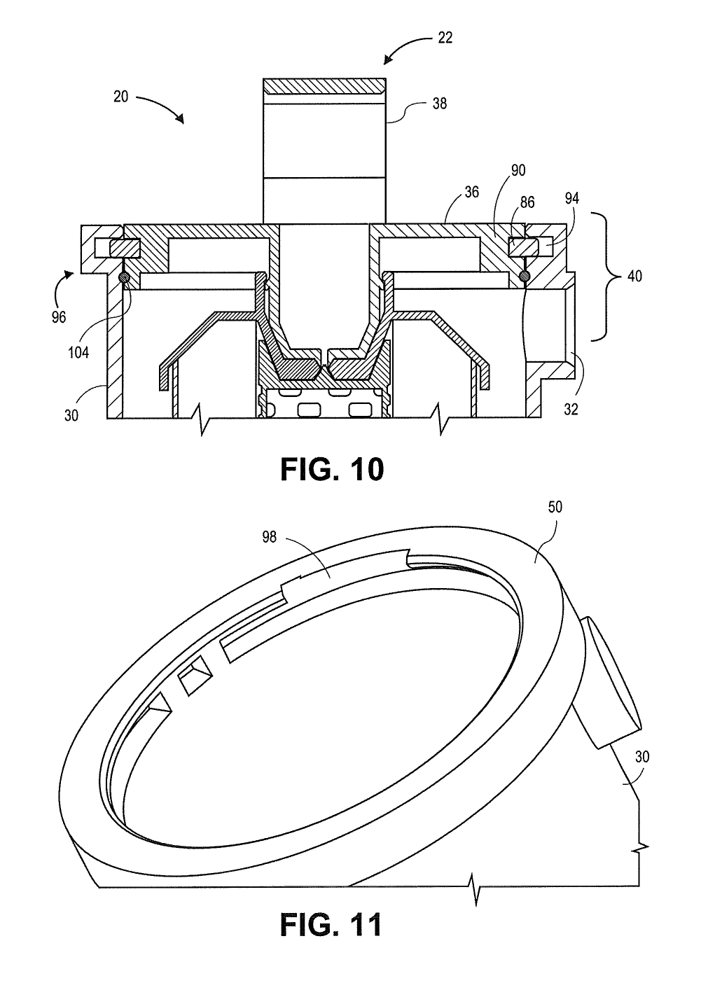

FIG. 10 is a cross sectional view of the filter cartridge assembly 20, according to another aspect of the disclosure. The example of the filter cartridge assembly 20 shown in FIG. 10 is similar to the example shown in FIGS. 1-9 and particularly FIG. 4 and thus, for the sake of brevity, those elements already discussed herein will not be described again. As shown in FIG. 10, the annular spring 88 is biased to reside partially within the lid groove 90. In this biased conformation, the annular spring 88 is configured to secure the lid 22 to the housing 30 by virtue of a portion of the annular spring being within the lid groove 90 and a portion of the annular spring 88 residing within the throat groove 94.

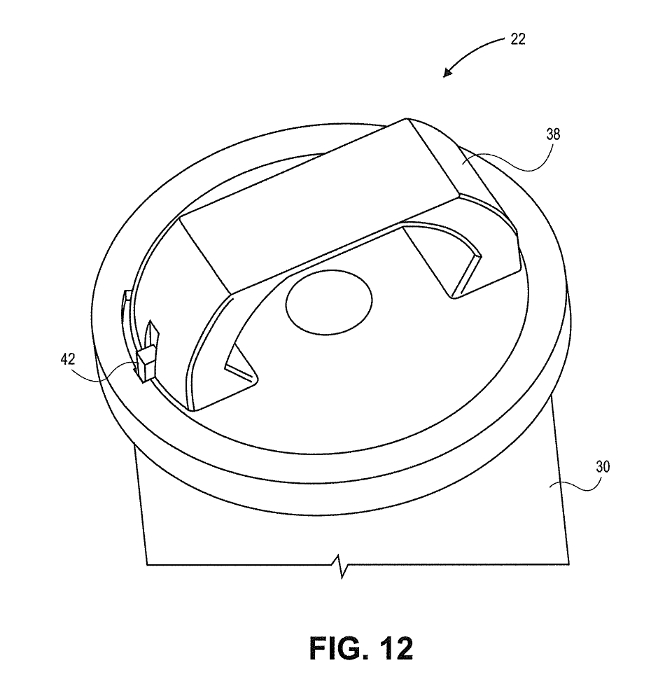

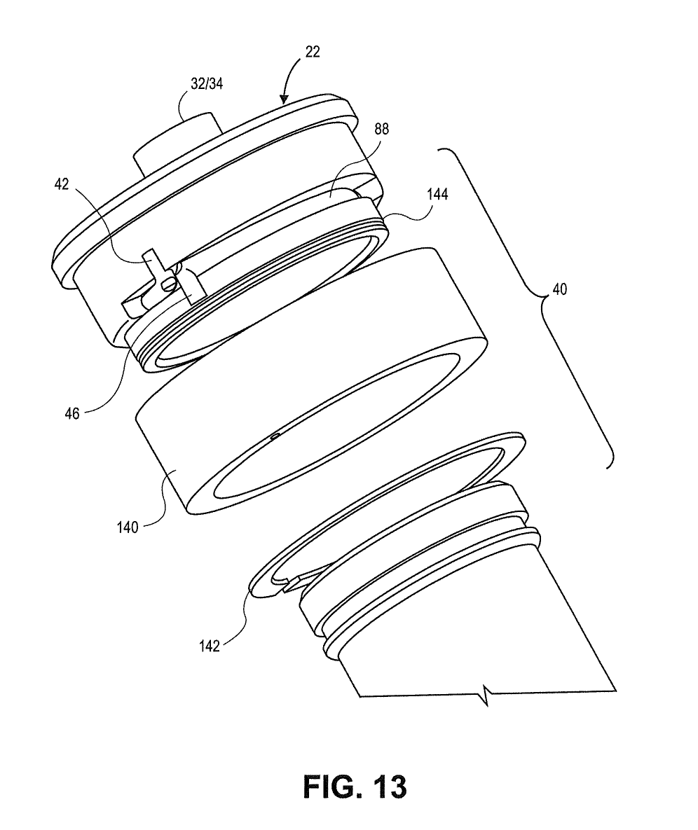

Now also referring to FIGS. 11 and 12, to release the lid 22 from the housing 30, the handle 38 is turned to increase the radius of the annular spring 88 and urge the annular spring 88 to fully reside within the throat groove 94. In this manner, the lid 22 may be withdrawn from the housing 30.

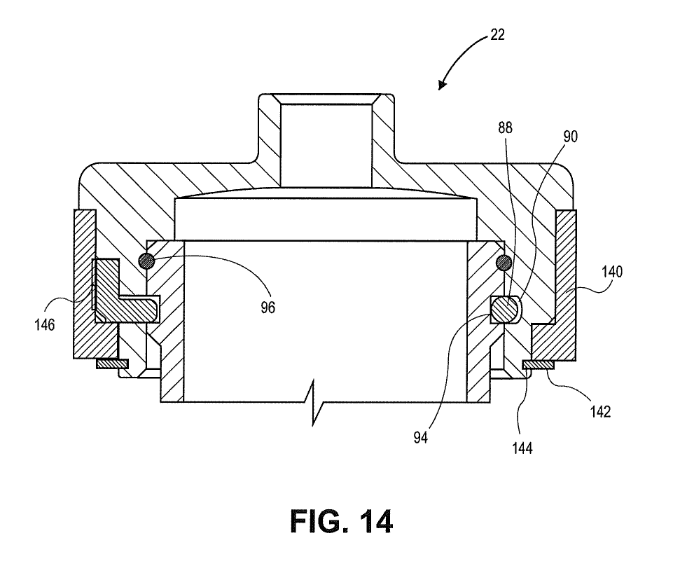

FIG. 13 is a partial exploded view of the filter cartridge assembly 20, according to yet another aspect of the disclosure. The example of the filter cartridge assembly 20 shown in FIG. 13 is similar to the example shown in FIGS. 1-12 and particularly FIG. 10 and thus, for the sake of brevity, those elements already discussed herein will not be described again. As shown in FIG. 13, the lid 22 includes the inlet 32 or the outlet 34. Also shown in FIG. 13, the fitting 40 includes a release ring 140 that is secured to the lid 22 via a retaining ring 142 that is configured to lock into a retaining groove 144. The release ring 140 includes a release ring notch 146 shown in FIG. 14. Also shown in FIG. 14, by rotating the release ring 140 relative to the lid 22, the radius of the annular spring 88 is enlarged such that the annular spring 88 fully resides within the lid groove 90 and the lid 22 may be removed from the housing 30. In the biased conformation, the annular spring 88 secures the lid 22 to the housing in a manner already discussed.

FIG. 14 is a cross sectional view of the filter cartridge assembly, according to yet another aspect of the disclosure.

### INDUSTRIAL APPLICABILITY

The present disclosure may be applicable to any machine including a fluid filter cartridge assembly. Aspects of the disclosed filter cartridge assembly may promote ease of use, greater ability to inspect and replace filters, operational flexibility, and performance of fluid filter housing assemblies in general and fuel systems in particular.

Applicants discovered that a conventional filter housing fitting did not provide sufficient ease of use to encourage proper inspection and replacement of filter cartridges. Applicants further discovered that conventional filter housings required tools to tighten fitting and that a tool-less inspection and replacement of filter cassettes reduced the time and expense of inspecting and replacing filter cartridges. Applicants further yet discovered that the filter cassettes of conventional filter housings were difficult to remove without directly handling the filter cassette.

According to an aspect of the disclosure shown in FIG. 2, the handle 38 provides an easy and convenient torqueing and pulling surface for the user to withdraw the filter cassette 60 as shown in FIG. 8. Returning to FIG. 2, the first catch 42 and second catch 46 are easily brought towards one another and release of the lid 22 from the housing 30 with a rotation of less than 15°.

According to an aspect of the disclosure shown in FIGS. 4 and 5, the distribution zone 102 generated by the sloping face 78 facilitates an even and low-restriction flow of the fuel about an upper portion of the filter cassette 60. This distribution of the flow of fuel about the upper portion of the filter cassette 60 facilitates improved flow around and down the filter cassette 60 and reduces low-flow areas which improves the filter performance of the filter cartridge assembly 20.

Accordingly, aspects of the disclosure enable ease of use to encourage proper inspection and replacement of filter cartridges, a tool-less inspection and replacement of filter cassettes reduced the time and expense of inspecting and replacing filter cartridges, replacement of filter cassettes without direct contact with the filter cassette, operational flexibility, and performance of fluid filter housing assemblies in general and fuel systems in particular.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified. The many features and advantages of the various aspects are apparent from the detailed specification, and thus, it is intended by the appended claims to cover all such features and advantages that fall within the true spirit and scope of the aspects. Further, since numerous modifications and variations will readily occur to those skilled in the art, it is not desired to limit the aspects to the exact construction and operation illustrated and described, and accordingly, all suitable modifications and equivalents may be resorted to, falling within the scope of the various aspects.

We claim:

1. A fitting comprising:
a lid including:
a circular body defined by a first surface, a second surface, and a perimeter;
a handle disposed upon the first surface, the handle being configured to receive torque and linear force and translate the torque and linear force to the circular body;
an annular lid groove disposed about the perimeter; and
an annular spring having a spring body, a first catch disposed at a first end of the spring body, and a second catch disposed at a second end of the spring body, the spring body being configured to mate with the annular lid groove, wherein the spring body is configured to fully reside within the annular lid groove in response to the first catch being drawn towards the second catch and wherein the spring body is configured to partially extend annularly outwardly from the annular lid groove in response to the first catch and the second catch being allowed to return to a biased position; and
a receiver including:
a throat defined by a cylindrical surface configured to mate with the perimeter of the circular body; and
a throat groove disposed about the throat, the throat groove being configured to receive the extended portion of the spring body partially extending from the annular lid groove, wherein the lid is captured in the receiver in response to the spring body mating with the throat groove.

2. The fitting according to claim 1, further comprising:
a lid notch to receive the first catch; and
a lip disposed above the annular receiver, the lip including a lip notch to receive the second catch, wherein in response to torque being applied to the lid to urge the first catch towards the second catch, the lid is released from the receiver.

3. The fitting according to claim 2, wherein the lid notch extends perpendicularly from the first surface.

4. The fitting according to claim 1, further comprising:
an annular seal disposed about the perimeter of the circular body between the annular lid groove and the second surface, the annular seal being configured to form a seal between the perimeter and the cylindrical surface of the throat.

5. The fitting according to claim 4, wherein the annular seal includes:
an O-ring; and
an O-ring seat defined by an annular channel seal disposed about the perimeter of the circular body between the annular lid groove and the second surface, wherein the O-ring seat is configured to retain the O-ring.

6. A filter cartridge assembly to filter a fluid, the filter cartridge assembly comprising:
a housing having an inlet and an outlet;
a filter medium disposed in the housing between the inlet and the outlet; and
a fitting including:
a lid including:
a circular body defined by a first surface, a second surface, and a perimeter;
a handle disposed upon the first surface, the handle being configured to receive torque and linear force and translate the torque and linear force to the circular body;
a clip
an annular lid groove disposed about the perimeter; and
an annular spring having a spring body, a first catch disposed at a first end of the spring body, and a second catch disposed at a second end of the spring body, the spring body being configured to mate with the annular lid groove, wherein the spring body is configured to fully reside within the annular lid groove in response to the first catch being drawn towards the second catch and wherein the spring body is configured to partially extend annularly outwardly from the annular lid groove in response to the first catch and the second catch being allowed to return to a biased position; and
a receiver disposed in the housing, the receiver including:
a throat sized to allow the filter medium to pass therethrough, the throat being defined by a cylindrical surface configured to mate with the perimeter of the circular body; and
a throat groove disposed about the throat, the throat groove being configured to receive the extended portion of the spring body partially extending from the annular lid groove, wherein the lid is captured in the receiver in response to the spring body mating with the throat groove.

7. The filter cartridge assembly according to claim 6, further comprising:
a lid notch to receive the first catch; and
a lip disposed above the annular receiver, the lip including a lip notch to receive the second catch, wherein in response to torque being applied to the lid to urge the first catch towards the second catch, the lid is released from the receiver.

8. The filter cartridge assembly according to claim 7, wherein the lid notch extends perpendicularly from the first surface.

9. The filter cartridge assembly according to claim 6, further comprising:
an annular seal disposed about the perimeter of the circular body between the annular lid groove and the second surface, the annular seal being configured to form a seal between the perimeter and the cylindrical surface of the throat.

10. The filter cartridge assembly according to claim 9, wherein the annular seal includes:
an O-ring; and
an O-ring seat defined by an annular channel seal disposed about the perimeter of the circular body between the annular lid groove and the second surface, wherein the O-ring seat is configured to retain the O-ring.

11. The filter cartridge assembly according to claim 6, further comprising:
a filter mounting post disposed on the second surface of the circular body; and
a retention clip extending from the filter medium, the retention clip being configured to engage the filter mounting post.

12. The filter cartridge assembly according to claim 11, wherein the filter medium includes a downwardly sloping face disposed conically about an end of the filter medium and proximal to the retention clip, wherein the downwardly sloping face is configured to increase a volume of the fluid between the second surface and the filter medium.

13. The filter cartridge assembly according to claim 11, wherein the filter medium includes a top end cap disposed between the retention clip and the filter medium, the top end cap including an interface seal with the filter mounting post

14. The filter cartridge assembly according to claim 6, wherein the filter medium includes a pleated cellulose medium.

15. The filter cartridge assembly according to claim 14, wherein the filter medium includes a spiral roving wound about the pleated cellulose medium to retain separation between adjacent ones of the pleats.

16. The filter cartridge assembly according to claim 6, further comprising:
an inlet to allow a flow of the fluid to enter the housing; and
an outlet to allow a filtered flow of the fluid to exit the housing.

17. The filter cartridge assembly according to claim 16, wherein the outlet includes:
a conduit having a first end and a second end, the first end being configured to form a filter seal with a center tube of the filter medium, the second end being configured to form a housing seal at a perimeter of a bore disposed through the housing.

18. A machine comprising the filter cartridge assembly according to claim 6.

19. The machine according to claim 18, wherein the machine is an excavator.

20. The machine according to claim 18, wherein the machine is a vehicle.
